(19) United States
(12) Patent Application Publication
(10) Pub. No.: US 2023/0325301 A1
(43) Pub. Date: Oct. 12, 2023

(54) MACHINE LEARNING-BASED VALUE-RANGE PRUNING FOR DIRECTED FUZZING

(71) Applicant: Baidu USA, LLC, Sunnyvale, CA (US)

(72) Inventors: Qian FENG, Mountain View, CA (US); Zhaofeng CHEN, San Jose, CA (US); Zhenyu ZHONG, San Jose, CA (US); Kang LI, Santa Clara, CA (US)

(73) Assignee: Baidu USA LLC, Sunnyvale, CA (US)

(21) Appl. No.: 17/715,827

(22) Filed: Apr. 7, 2022

(51) Int. Cl. G06F 11/36; G06N 20/00

(52) U.S. Cl. CPC G06F 11/3632; G06N 20/00

(57) ABSTRACT

Embodiments generate effective mutation directions for fuzzing by using an abstract interpretation engine that for each of a set of input variables determines whether, for an input value range, a source code comprises a potential bug. The abstract interpretation engine generates a list of potential bugs that is provided to a machine learning engine (e.g., a reinforcement learning engine) that, iteratively for each potential bug, generates a learned input value range that is narrower than the input value range. The learned input value range is provided to the abstract interpretation engine, which updates the input value range, and to a fuzzer, which limits a search space for generating a set of seeds that is used to identify bugs in the source code.

### COPYRIGHT NOTICE

A portion of the disclosure in this patent document contains material that is subject to copyright protection. The copyright owner has no objection to the facsimile reproduction by anyone of the patent document as it appears in the Patent and Trademark Office patent file or records, but otherwise reserves all copyright rights whatsoever.

### BACKGROUND

### A. Technical Field

The present disclosure relates generally to systems and methods for applied machine learning that can provide improved computer performance, features, and uses. More particularly, the present disclosure relates to increasing fuzzing efficiency by utilizing program analysis systems and methods, such as abstract interpretation-based techniques.

### B. Background

Fuzzing or fuzz testing is an efficient method for detecting bugs. Used as an effective software security tool, it may expose programming errors that otherwise cause faulty software behavior, such as memory buffer errors or program crashes, and potential software security vulnerabilities. Fuzzing utilizes test automation to iteratively feed manipulated inputs to a software program and execute a target code to trigger security bugs in the tested target code, ideally, obtaining as few false positive or false negative results as possible. Bugs may then be examined and corrected to prevent potential software security vulnerabilities. Generating “good” seeds, i.e., initial inputs, for fuzzing may benefit from guidance by program analysis to improve fuzzing efficiency. Such guidance may be provided in the form of edge coverage, path coverage, or potential bug locations. Yet, there are no known program analysis techniques that can guarantee that the guidance is mathematically sound. In fact, existing guidance oftentimes results in fuzzing in a wrong direction. Accordingly, what is needed are novel systems and methods that avoid the shortcomings of existing approaches.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

FIG. 1 depicts an exemplary fuzzing system according to embodiments of the present disclosure.

FIG. 2 depicts an exemplary code fragment that illustrates how an abstract interpretation engine may conduct program analysis.

FIG. 3 depicts a flowchart of an illustrative process for increasing fuzzing efficiency, according to embodiments of the present disclosure

FIG. 4 depicts a simplified version of the flowchart in FIG. 3.

FIG. 5 depicts a simplified block diagram of an information handling system (or computing system), according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The use of memory, database, information base, data store, tables, hardware, cache, and the like may be used herein to refer to system component or components into which information may be entered or otherwise recorded. A set may contain any number of elements, including the empty set.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

It is noted that although embodiments described herein may be within the context of abstract interpretation utilizing a reinforcement learning engine, aspects of the present disclosure are not so limited. Accordingly, aspects of the present disclosure may be applied or adapted for use in program analysis that does utilizes other means of obtaining inputs for fuzzers that are suitable for increasing fuzzing efficiency, including approaches do not involve machine learning.

In this document, the terms “program” and “software” may be used interchangeably. Similarly, the terms “testing,” “seed sampling,” and “fuzzing” and the terms “input value range” and “input range” may be used interchangeably. The term “bug” refers to. As commonly use in the art, the term “bug” or “software bug” refers to unintended or faulty software behavior that results from coding errors.

A. General Background Information

Abstract interpretation is a practical verification approach that can provide a sound analysis of a target program. Given an input value range, abstract interpretation may be used to detect potential bugs and their locations in a program, which may be used to guarantee that there are no bugs in a certain value range. Various embodiments herein leverage reinforcement learning to prune an input value range to find a reduced or minimized input value range that still can trigger bugs. Advantageously, this learned value range may then be used to greatly improve fuzzing efficiency. The rationale behind this is that seeds need not mutate in a direction of a particular range that contains no bugs.

Hybrid fuzzing utilizes concolic execution as guidance to increase fuzzing efficiency. On one hand, fuzzing provides seeds for concolic execution to generate concreate paths for symbolic execution. On the other hand, concolic execution can solve complex branch constraints and provide seeds for fuzzing to explore. However, hybrid fuzzing does not address the fuzzing direction issue. That is, the hybrid fuzzing approach blindly explores the entire search space of a program with no guarantee that a bug exists in a current direction. Similarly, Angora aims at increasing branch coverage by solving path constraints without symbolic execution. However, this approach, too, cannot guarantee that a bug exists in the current direction.

SAVIOR utilizes American fuzzy lop (AFL) as a fuzzing engine and employs KLEE as its backend concolic execution engine to verify the execution path for potential bugs. Although this approach can verify whether a current execution path contains a bug or not, it suffers from the limitation of not having a direction and blindly exploring the entire search space of a program to verify each executed path.

GREYONE adopts a data flow-sensitive fuzzing method that utilizes taint analysis to selects bytes to mutate. Each bit of the entire input value range must be mutated. In addition, only data-flow analysis is supported but not control-flow analysis. Therefore, it is difficult to determine which bytes to mutate as there is not data-flow dependency between the input and a target branch. In comparison, embodiments herein utilize abstract interpretation, which considers both data-flow and control-flow, thereby, providing a more complete analysis.

NEUZZ utilizes a smooth surrogate function method to approximate the behavior of a target program to find an appropriate input, which, in practice, is difficult to apply and tends to suffer from low precision for non-linear programs.

In contrast, embodiments herein that use abstract interpretation, which utilizes an interval domain to model the program domain and conducts a precise value analysis to model the program. As such, abstract interpretation supports non-linear programs. Further, abstract interpretation uses an over-approximation technique that guarantees the soundness of its analysis.

Fuzzing involves random testing on a target program by mutating input seeds. However, the mutating space is complex and large, especially when the input is a structural object, such as a file(s). Therefore, guidance from the program analysis is important and can provide prior knowledge that may guide fuzzing in the mutation direction. Therefore, in one or more embodiments, an abstract interpretation-based approach is utilized to guide fuzzing, e.g., by providing an effective mutation direction. Since abstract interpretation can provide sound results, i.e., bug lists given an input value range, that value range may be used as the mutation direction to guide fuzzing. If abstract interpretation confirms that no bugs are present in a certain input value range, no fuzzing needs to be performed, i.e., that particular range may be skipped, and focus may be diverted to an input range that may comprise bugs. As a result, fuzzing can advantageously avoid futile fuzzing attempts in the wrong direction. In addition, since abstract interpretation conducts thorough data-flow and control-flow analyses, embodiments herein tend to obtain more precise guidance than data-flow-only approaches such as GREYONE.

Finding a minimum value range, which is a search problem, remains a nontrivial undertaking. Absent a good search strategy, all combinations of all possible intervals of a value range must be explored. As such, this presents a non-deterministic polynomial-time (NP)-hard problem. In one or more embodiments, reinforcement learning is utilized to find a minimum value range. Unlike ad hoc searching or exhaustive searching, reinforcement learning may, advantageously, adjust its search strategy based on feedback from abstract interpretation to ultimately produce a fair solution.

B. Overview

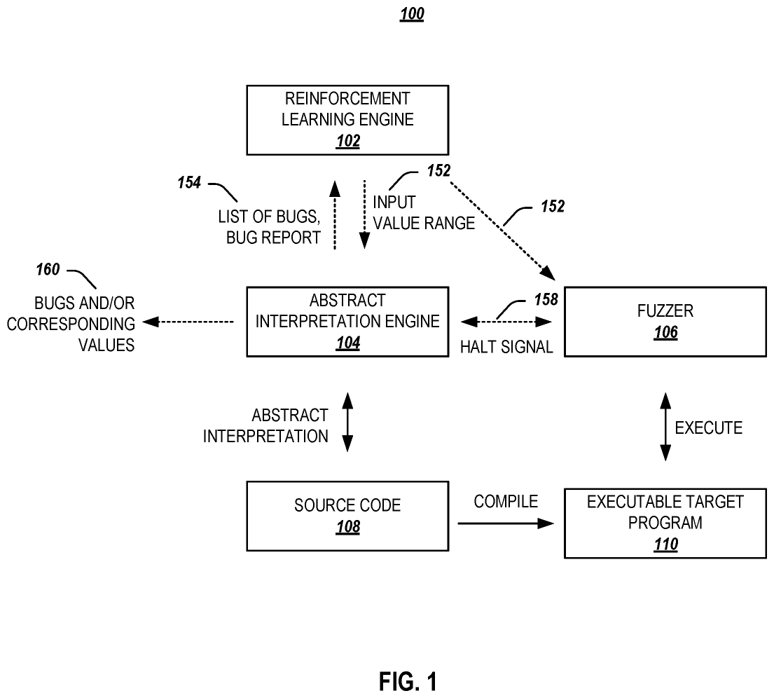

In one or more embodiments, an input value range may be pruned using an abstract interpretation-based approach in order to guide fuzzing by providing an effective mutation direction. FIG. 1 depicts an exemplary fuzzing system according to embodiments of the present disclosure. A suitable pruning method may utilize a machine learning engine (e.g., reinforcement leaning engine 102), abstract interpretation engine 104, and fuzzer 106. It is understood that some or all of reinforcement leaning engine 102 may be embedded in abstract interpretation engine 104 and vice versa.

In operation, in one or more embodiments, abstract interpretation engine 104 may use a given initial input value range, e.g., a min-max domain or interval, which may be defined by a computer architecture, to conduct an abstract interpretation or code analysis on source code 108 of target program 110 to determine whether source code 108 comprises any potential bugs. If so, abstract interpretation engine 104 may generate a list of potential bugs 154 and provide list 154 to reinforcement leaning engine 102. In one or more embodiments, reinforcement leaning engine 102, in response to receiving confirmation from abstract interpretation engine 104 that input value range 152 comprises a potential bug, may refine or update initial input value range to generate a refined input value range 152.

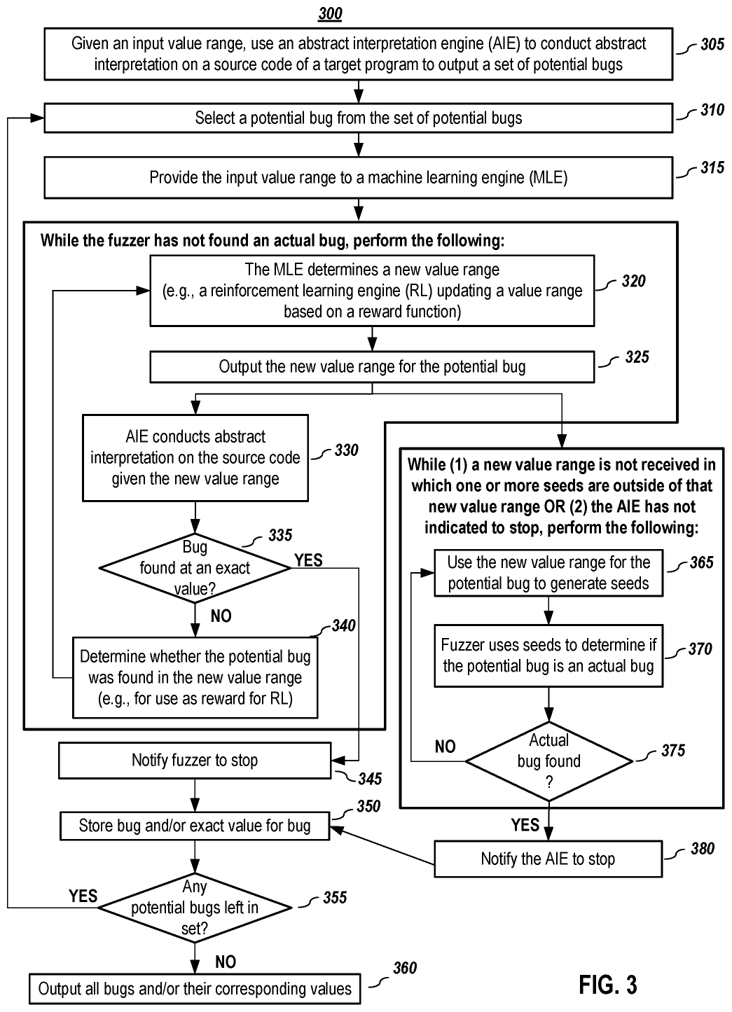

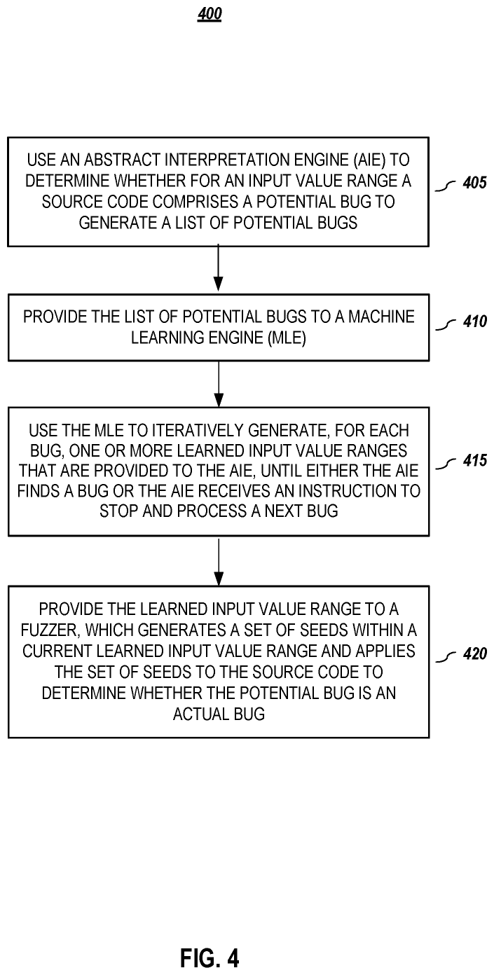

As discussed in greater detail below with reference to FIG. 3 and FIG. 4, in one or more embodiments, once abstract interpretation engine 104 determines that updated input value range 152 does not comprise a potential bug, reinforcement leaning engine 102 may discard that range and generate or a learn a new input value range 152 that may serve as a reasonable domain for fuzzer 106 to generate a set of seeds, e.g., a domain that narrows the search space of fuzzer 106 and, thus, increases its efficiency. It is understood that abstract interpretation engine 104 may be used to provide a value range for each variable in source code 108 and that this variable range may be used as a search space for fuzzer 106 to generate a seed to fuzz target program 110 without fuzzing the entire search space.

Since processing times of reinforcement leaning engine 102 are typically greater that than those of fuzzer 106, in one or more embodiments, to prevent fuzzer 106 from idling, once abstract interpretation engine 104 feeds back information 154 about whether a potential bug is found in a range to reinforcement leaning engine 102, reinforcement leaning engine 102 may update the input range and provide updated input range 152 also to fuzzer 106. Advantageously, this allows fuzzer 106 to conduct mutation using updated input value range 152 to fuzz target program 110 with the resulting mutated seeds to verify whether a potential bug is an actual bug; or stated differently, whether a result by abstract interpretation engine 104 is a true positive or false positive. It is understood that abstract interpretation engine 104 and fuzzer 106 may, e.g., upon finding an actual bug, may use halt signal 158 to stop each other's operation, e.g., to process the next potential bug in a set of potential bugs, thereby, saving computing resources and time, as discussed in greater detail below.

C. Abstract Interpretation Embodiments

Abstract interpretation is verification technique that can enable static program analyzers to automatically discover properties of the run-time behavior of programs at compile time, since abstract interpretation over-approximates the semantics of a program to guarantee the soundness of the analysis result. Abstract interpretation is a one-sided analysis, i.e., if no alarm is reported, a property or behavior of a program is verified. However, abstract interpretation tends to produce true positive and false positive alarms, i.e., reports a bug when none exists.

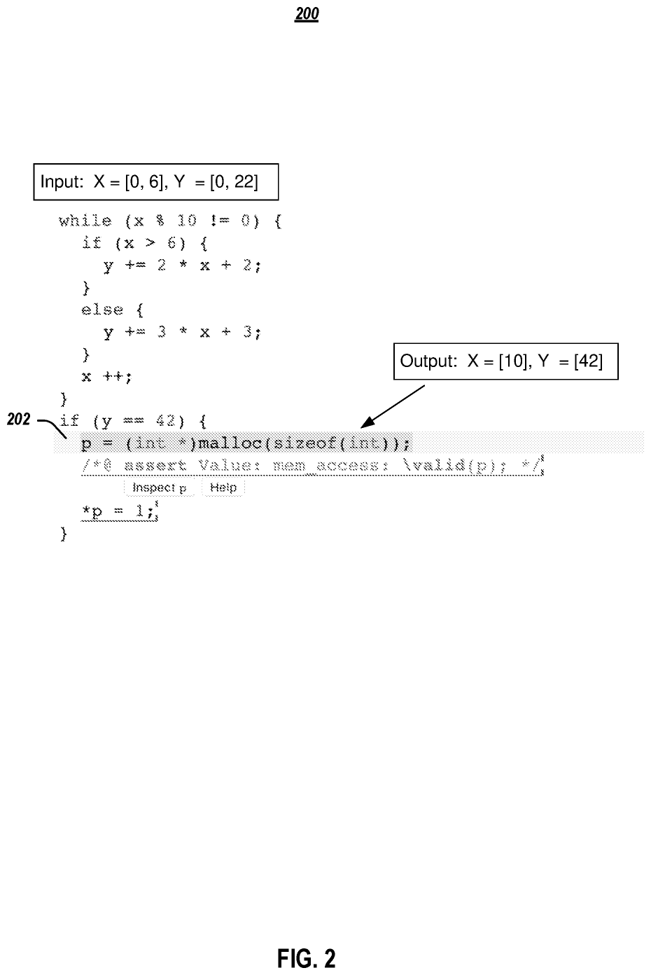

FIG. 2 depicts an exemplary code fragment that illustrates how an abstract interpretation engine may conduct an analysis. Given inputs X and Y, which have respective interval domains [0,6] and [0,22] shown in FIG. 2, an abstract interpretation engine may conduct an interval analysis on code 200 and output alerts at line 202. In one or more embodiments, the abstract interpretation engine may employ a reinforcement learning engine to learn an input value range, e.g., the intervals of X and Y. The abstract interpretation engine may then use the learned input value range to guide a fuzzer away from futile value ranges or attempts in the wrong direction to increase fuzzing efficiency.

D. Model-Based Reinforcement Learning Embodiments

In one or more embodiments, a reinforcement learning engine may be implemented as an agent that acts as the learner and decision maker who interacts with the so-called environment. The agent may obtain a reward from the environment depending on actions at each state.

1. State

The set of states, S, is a set of intervals for input variables P×N in which P is the interval, and N represents the number of variables. The initial values of states, S, comprise the entire value range based on type. For example, if the initial values are integers, the value range may be [INT_MIN, INT_MAX].

2. Action

Regarding action A:
A(s)={ [symbol] u₁ [symbol] , 2 [symbol] , . . . , [symbol] uₙ [symbol] , 2 [symbol] } (subsets)
∪{ [symbol] L\u₁, n−1 [symbol] , . . . , [symbol] L\uₙ, n−1 [symbol] } (complements)
∪{ [symbol] L, 2n [symbol] } (more granularity)

The subset means the subset of an interval (a, b), and complement means the complement of an interval (a, b). The more granularity means that we will divide the current range by 2.

3. Transition Function

Regarding transition function T:

$$T ( {s}^{′} \vert s , a ) = \{ \begin{matrix}1 & ( {s}^{′} = 〈 {u}_{i} , 2 〉 , 𝒪 ( {u}_{i} ) = T ) \\ 1 & ( {s}^{′} = 〈 L \backslash {u}_{i} , n - 1 〉 , 𝒪 ( L \backslash {u}_{i} ) = T ) \\ 1 & ( {s}^{′} = 〈 L , 2 n ) , ∄ i , 𝒪 ( {u}_{i} ) = T ⋁ 𝒪 ( L \backslash {u}_{i} ) = T ) \\ 0 & ( otherwise )\end{matrix}$$

A state transition occurs only when either a next candidate program exhibits the desired property (the first two cases) or more granularity in dividing programs is necessary since none of them are desirable (the third case). If none of the first three cases get desired properties, no further action will be taken. The entire process will exit.

4. Reward Function

Regarding Reward Function R:

$$R ( 〈 L , n 〉 ) = \{ \begin{matrix}1 & ( L is 1 - minimal ) \\ 0 & ( otherwise )\end{matrix}$$

The reward 1 may assigned when the abstract interpretation finds bugs in a current input value range. Otherwise, the assigned reward may be 0.

E. Fuzzing Embodiments

In one or more embodiments, the machine learning engine may cause the abstract interpretation engine to run several times prior to detecting an actual bug. However, since abstract interpretation is a process that is relatively slower than the fuzzing process, instead of waiting for the machine learning engine to finish, in one or more embodiments, to prevent a fuzzer from idly waiting for a new value range, the fuzzer may be allowed use an intermediate input value range that is provided, e.g., by the machine learning engine, to commence testing before the machine learning engine generates a new input value range.

It is noted that mutation policies that are built into existing fuzzers such as AFL, which conduct mutations without considering value ranges, may cause seeds to be mutated outside of a provided range. Therefore, one or more embodiments herein provide for a novel seed sampling engine that can provide new random mutation policies to conduct mutation within a specific range, e.g., an intermediate input value range provided by a reinforcement learning engine. Advantageously, such seed sampling engine may be suitable for use with any AFL fuzzer whose mutation feature is disabled.

FIG. 3 depicts a flowchart of an illustrative process for increasing fuzzing efficiency and thus bug detection efficiency in computer code, according to embodiments of the present disclosure. In one or more embodiments, process 300 may begin when, given an input value range, e.g., for an input variable comprising a lower and upper bound that is defined by a computer architecture, an abstract interpretation engine is used to conduct abstract interpretation (305) on a source code of a target program. Abstract interpretation may yield a set of potential bugs that may be output and provided to a machine learning engine, e.g., a reinforcement learning engine, and a potential bug may then be selected (310) from the set of potential bugs for further processing.

In one or more embodiments, the machine learning engine may be provided (315) with the input value range and use the input value range to determine (320) a new value range, which is updated throughout a number of iterations. In embodiments where the machine learning engine is a reinforcement learning engine, the reinforcement learning engine may, e.g., for the selected potential bug, determine a new value range that is narrower than the input value range. For example, in a first iteration, the reinforcement learning engine may further narrow the new value range, e.g., by based on a reward function.

In one or more embodiments, each new value range may be provided (325), e.g., in one of or a row or column of a matrix, to the abstract interpretation engine and to a fuzzer, which may use the new value range for the potential bug to generate (365) one or more seeds. The fuzzer may process the seeds in any order to execute some or all of the source code to determine (370) whether the potential bug, i.e., the current bug is an actual bug. If the fuzzer finds (375) an actual bug, it may notify (380) the abstract interpretation engine to halt processing of the current value range. Otherwise, if the fuzzer cannot confirm that the potential bug is an actual bug, process 300 may continue the fuzzing process at step 365. It is noted that the iteration of steps 365 through 375 of the fuzzing process may be interrupted when either the fuzzer receives from the abstract interpretation engine a notification to stop or the fuzzer receives a new value range in which one or more current seeds fall outside of that value range.

In one or more embodiments, in response to receiving a new value range, the abstract interpretation engine may use that range to conduct abstract interpretation (330) on the source code to determine (340) whether or not the potential bug was found in the range and report the finding to the machine learning engine. Unless the potential bug was found (335) at an exact value or location, i.e., it is an actual bug, the machine learning engine may commence a new iteration at step 320, e.g., by using any reinforcement learning method known in the art to update the new value range. In one or more embodiments, any of steps 320 through 340 may be interrupted in response to the fuzzer finding an actual bug, at which time process 300 may resume with determining (355) whether any other potential bugs are left in the set of potential bugs.

In one or more embodiments, if a potential bug is found (335) at an exact value, the abstract interpretation engine may notify (345) the fuzzer to stop its current iteration within its current new value range. The actual bug and/or an exact value for the bug may be stored (350) and process 300 may resume with selecting (310) the next potential bug from the set of potential bugs. Otherwise, if it is determined (355) that there are no bugs left in the set of potential bugs, all potential bugs and/or their corresponding values may be output (360).

It is noted that the machine learning engine may update the new value range using any operation known in the art to increase a probability that an input variable triggers a bug in the source code, including determining a narrower subset of the new value range, determining a range that is a complement of the new value range, increasing the granularity of a new value range, and the like.

In one or more reinforcement learning engine embodiments, the reinforcement learning engine may use the presence of the potential bug in the new value range, i.e., the fact that the abstract interpretation engine found the potential bug in the new value range, as a reward, e.g., in a reward function that causes the reinforcement learning engine to update the new value range, e.g., in a training process. Conversely, the reinforcement learning engine may use an absence of the potential bug in the new value range, i.e., the fact that the abstract interpretation engine did not find the potential bug in the new value range, in an action to exclude the new value range, e.g., when updating the new value range. As a result, the fuzzer may use a limited search space as a mutation direction to generate seeds. This prevents the fuzzer from processing an input value range that may be less efficient than the new value range, i.e., no resources need to be wasted on fuzzing in an input value range that triggers no bugs in the source code.

Advantageously, narrowing the fuzzer's search space in this manner generates effective mutation directions for the fuzzing process and increases the efficiency of the fuzzer. It shall be noted that: (1) certain steps may optionally be performed; (2) steps may not be limited to the specific order set forth herein; (3) certain steps may be performed in different orders; and (4) certain steps may be done concurrently.

FIG. 4 depicts a flowchart of a simplified process for increasing fuzzing efficiency according to embodiments of the present disclosure. In one or more embodiments, process 400 may commence by using an abstract interpretation engine to determine (405), e.g., for each of a set of input variables, whether for an input value range a source code comprises a potential bug. The abstract interpretation engine may generate and output a list of potential bugs that is provided (410) to a machine learning engine, e.g., a reinforcement learning engine. In one or more embodiments, for each bug, the machine learning engine may iteratively generate (415) an updated or learned input value range that is, e.g., a narrower subset of the input value range and provide the updated or learned input value range to the abstract interpretation engine. In one or more embodiments, this narrowing may continue, e.g., until either the abstract interpretation engine finds a bug, or the abstract interpretation engine receives an instruction to stop and process a next bug in the list of potential bugs.

One or more embodiments provide (420) the learned input value range to a fuzzer that, in response to receiving the learned input value range, may limit a search space and use the limited search space to generate a set of seeds within a current learned input value range and apply the set of seeds to the source code to test a target program to determine whether the potential bug is an actual bug.

In one or more embodiments, a stop condition may include: (1) a set number of iterations have been performed; (2) an amount of processing time has been reached; (3) convergence (e.g., the difference between consecutive iterations is less than a threshold value); (4) divergence (e.g., the performance deteriorates); (5) an acceptable outcome has been reached; and (6) all of the data has been processed.

F. System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

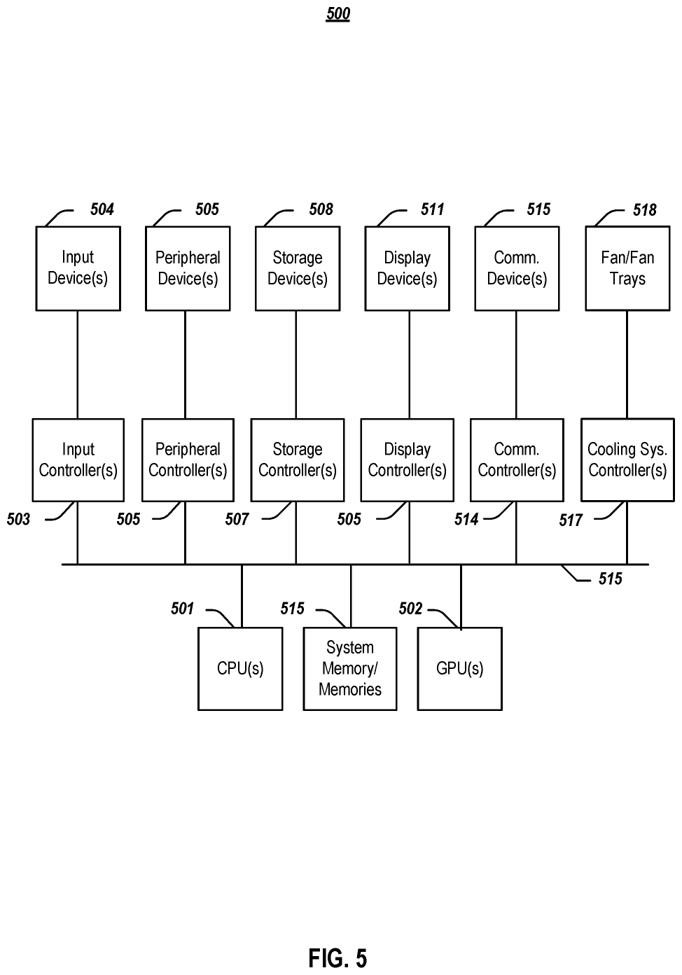

FIG. 5 depicts a simplified block diagram of an information handling system (or computing system), according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more CPUs 501 that provide computing resources and control the computer. CPU 501 may be implemented with a microprocessor or the like, and may also include one or more graphics processing units (GPU) 502 and/or a floating-point coprocessor for mathematical computations. In one or more embodiments, one or more GPUs 502 may be incorporated within the display controller 509, such as part of a graphics card or cards. Thy system 500 may also include a system memory 519, which may comprise RAM, ROM, or both.

A number of controllers and peripheral devices may also be provided, as shown in FIG. 5. An input controller 503 represents an interface to various input device(s) 504. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 508 may also be used to store processed data or data to be processed in accordance with the disclosure. The system 500 may also include a display controller 509 for providing an interface to a display device 511, which may be a cathode ray tube (CRT) display, a thin film transistor (TFT) display, organic light-emitting diode, electroluminescent panel, plasma panel, or any other type of display. The computing system 500 may also include one or more peripheral controllers or interfaces 505 for one or more peripherals 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 500 comprises one or more fans or fan trays 518 and a cooling subsystem controller or controllers 517 that monitors thermal temperature(s) of the system 500 (or components thereof) and operates the fans/fan trays 518 to help regulate the temperature.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for efficient bug detection in computer code, the method comprising:
given an input value range, using an abstract interpretation engine (AIE) to conduct abstract interpretation on a source code of a target program, the AIE determines a set of potential bugs;
selecting a potential bug from the set of potential bugs;
for the selected potential bug, providing the input value range to a machine learning engine (MLE) that determines a new value range;
providing the new value range to the AIE and a fuzzer, the fuzzer performs steps comprising, while either no updated range in which one or more seeds are outside of the updated range is received or the fuzzer has not received from the AIE a notification to stop, performing steps comprising:
using the new value range to generate seeds;
using the seeds to determine whether the potential bug is an actual bug; and
in response determining that the potential bug is an actual bug, instructing the AIE to move to a next potential bug among the set of potential bugs;
in response to the AIE conducting abstract interpretation on the source code using the new value range, notifying the MLE whether or not the potential bug was found in new value range;
resuming with the MLE determining a next new value range;
in response to the AIE finding the potential bug at an exact value, notifying the fuzzer to stop processing the new value range;
storing at least one of the potential bug or the exact value for the potential bug; and
in response to determining that no potential bugs are left in the set of potential bugs, outputting at least one of one or more potential bugs or one or more values corresponding to the one or more potential bugs.

2. The computer-implemented method of claim 1, wherein the MLE is a reinforcement learning engine (RLE) that, after a first iteration, updates the input value range based on a reward.

3. The computer-implemented method of claim 2, wherein the RLE generates an action that comprises assigning a first reward to the AIE finding the potential bug in the new value range.

4. The computer-implemented method of claim 3, wherein the first reward causes the RLE to update the new value range.

5. The computer-implemented method of claim 3, wherein the action that comprises assigning a second reward to the AIE not finding the potential bug in the new value range.

6. The computer-implemented method of claim 5, wherein the second reward causes the RLE to exclude the new value range when determining a subsequent new value range, thereby, increasing an efficiency of the fuzzer.

7. The computer-implemented method of claim 2, wherein, for each input variable in a set of input variables, the input value range serves as an initial state for the RLE, the RLE generating the new value range by performing one or more operations that increase a probability that the input variable triggers the potential bug in the source code.

8. The computer-implemented method of claim 7, wherein the one or more operations comprise at least one of determining a subset of the new value range, determining a complement of the new value range, or increasing a granularity of the new value range.

9. A system for generating effective mutation directions for fuzzing, the system comprising:
a machine learning engine (MLE) that, for a potential bug, performs steps until a stop condition has been reached, the steps comprising generating one or more learned ranges that each is a subset of an input value range;
an abstract interpretation engine (AIE) coupled to the MLE, the AIE performing steps comprising:
given the input value range, conducting abstract interpretation on a source code of a target program to detect a set of potential bugs comprising the potential bug; and
in response to obtaining a learned range from the MLE, using the learned range to conduct abstract interpretation on the source code to detect the potential bug; and
a fuzzer coupled to the AIE, the fuzzer, in response to obtaining the learned range, performs steps comprising:
generating a set of seeds; and
applying the set of seeds to the source code to determine whether the potential bug is an actual bug.

10. The system of claim 9, wherein the MLE communicates to the fuzzer the learned range for an input variable among a set of input variables in one of or a row or column of a matrix.

11. The system of claim 10, wherein the input variable comprises a lower and upper bound that is defined by a computer architecture.

12. The system of claim 10, wherein, for each input variable in the set of input variables, the MLE generates the learned range by performing one or more operations that increase a probability that the input variable triggers the actual bug in the source code.

13. The system of claim 12, wherein the MLE is a reinforcement learning engine and wherein the one or more operations comprise at least one of determining a subset of the learned range, determining a complement of the learned range, or increasing a granularity of the learned range.

14. The system of claim 9, wherein the fuzzer uses the learned range to obtain a limited search space.

15. The system of claim 14, wherein the fuzzer uses the limited search space as a mutation direction to generate the set of seeds.

16. A non-transitory computer-readable medium or media comprising one or more sequences of instructions which, when executed by at least one processor, causes steps for efficient bug detection in computer code comprising:
given an input value range, using an abstract interpretation engine (AIE) to conduct abstract interpretation on a source code of a target program, the AIE determines a set of potential bugs;
selecting a potential bug from the set of potential bugs;
for the selected potential bug, providing the input value range to a machine learning engine (MLE) that determines a new value range;
providing the new value range to the AIE and a fuzzer, the fuzzer performs steps comprising, while either no updated range in which one or more seeds are outside of the updated range is received or the fuzzer has not received from the AIE a notification to stop, performing steps comprising:
using the new value range to generate seeds;
using the seeds to determine whether the potential bug is an actual bug; and
in response determining that the potential bug is an actual bug, instructing the AIE to move to a next potential bug among the set of potential bugs;
in response to the AIE conducting abstract interpretation on the source code using the new value range, notifying the MLE whether or not the potential bug was found in new value range;
resuming with the MLE determining a next new value range;
in response to the AIE finding the potential bug at an exact value, notifying the fuzzer to stop processing the new value range;
storing at least one of the potential bug or the exact value for the potential bug; and
in response to determining that no potential bugs are left in the set of potential bugs, outputting at least one of one or more potential bugs or one or more values corresponding to the one or more potential bugs.

17. The non-transitory computer-readable medium or media of claim 16, wherein the MLE determines the new value range by performing one or more operations comprising at least one of determining a subset of the new value range, determining a complement of the new value range, or increasing a granularity of the new value range.

18. The non-transitory computer-readable medium or media of claim 16, further comprising, generating an action that comprises assigning a first reward to the AIE finding the potential bug in the new value range, the first reward causing the new value range to be updated.

19. The non-transitory computer-readable medium or media of claim 18, wherein the action comprises assigning a second reward to the AIE not finding the potential bug in the new value range.

20. The non-transitory computer-readable medium or media of claim 19, wherein the second reward causes the new value range to be excluded from a subsequent new value range to increase an efficiency of the fuzzer.
